(19) United States
(12) Patent Application Publication
(10) Pub. No.: US 2020/0030894 A1
(43) Pub. Date: Jan. 30, 2020

(54) Drilling Tool Comprising A Replaceable Cutting Disk

(71) Applicant: BOTEK PRAEZISIONSBOHRTECHNIK GMBH, RIEDERICH (DE)

(72) Inventor: Juergen Deeg, Metzingen (DE)

(73) Assignee: BOTEK PRAEZISIONSBOHRTECHNIK GMBH, RIEDERICH (DE)

(21) Appl. No.: 16/496,745

(22) PCT Filed: Mar. 27, 2018
(86) PCT No.: PCT/EP2018/057704

§ 371 Date: Sep. 23, 2019

(30) Foreign Application Priority Data
Apr. 4, 2017 (DE) 10 2017 107 249.7

(51) Int. Cl. B23B 51/04

(52) U.S. Cl. CPC B23B 51/0493; B23B 2251/56; B23B 2251/422; B23B 2251/02

(57) ABSTRACT

Described are a drilling tool and a replaceable cutting disk which allow the replaceable cutting disk to be positioned with high accuracy and in a form-locking manner in the drilling tool. At the same time, a cutting disk can be replaced more easily.

### BACKGROUND

The invention relates to a drilling tool having an exchangeable cutting disk for machining processes on drills, lathes, machining centers and other machine tools, and to a replaceable cutting disk therefor.

Drilling tools having a replaceable cutting disk are available in various designs; they are also known as replaceable disk drills.

Replaceable disk drills include a clamping end, a substantially cylindrical shank and a drill head. The clamping end is located at the rear end and the drill head is located at the front end. The shank is arranged therebetween. A longitudinal axis, which corresponds to the axis of rotation during drilling, extends from the clamping end to the drill head. A receptacle for the replaceable cutting disk is formed at the front end (drill head). The clamping end is a usually cylindrical receiving shaft for attaching the drilling tool to the machine spindle.

Finally, a cutting insert (replaceable cutting disk) is removably attached to the drill head, so that the torques resulting from the machining are transmitted from the cutting insert to the main body.

The clamping end, shank and drill head can be made in one piece. It is also possible to solder or otherwise attach the clamping end and/or the drill head to the shank. In this case, the drilling tool consists of two or three interconnected components. A receptacle for the replaceable cutting disk is formed in the drill head.

The replaceable cutting disk is made of a hard material that is suitable as a cutting material for machining, e.g. high-speed steel, sinter carbide, cermet or ceramic, which may also be provided with an additional layer of hard material in order to extend the service life, and has cutting edges for machining. A worn cutting insert can be exchanged for a new cutting insert when the wear limit is reached, so that the replaceable disk drill can be reused for further machining.

The main body, however, is designed for a longer service life and is provided for the use of several cutting inserts in succession. This results in a good operating efficiency of these drilling tools.

The chips produced at the tip of the drilling tool or the replaceable cutting disk are removed by at least two chip removal grooves, which extend from the front end towards the rear end and usually end before the clamping shaft. For greater drilling depths from approximately L/D=3, coolant is preferably used for flushing out the chips, which coolant is supplied from the rear end of the main body by cooling channels which extend in the main body from the rear to the front end and which have at least one opening at the rear end and have at least two openings at the front end.

This is well known to a person skilled in the art, and therefore a detailed explanation can be dispensed with.

The connection between a replaceable cutting disk and the drill head is very demanding, because the available space is dictated by the drill diameter and, in the case of high-performance tools, considerable torques and feed forces must be transferred from the drilling tool to the cutting disk. In addition, the requirements for the quality of the hole (surface, dimensional accuracy and straightness) are very high, so that exact positioning of the cutting disk in the drill head is of increasing importance.

The invention relates to the form-locking and easily detachable connection between a removable cutting disk and the drill head. This connection can be used in replaceable cutting disks with a wide variety of cutting geometries.

In order to describe the form-locking connection according to the invention between the replaceable cutting disk and the drill head, different terms from the field of geometry are used, which terms will be briefly defined below. These definitions correspond to the usual mathematical definitions, as can be found, for example, in the “Großes Handbuch der Mathematik”, edited by W. Gellert., Dr. H. Küstner, Dr. M. Hellwich and H. Kästner.

Parallel planes: Two planes are parallel if they are at the same distance from one another at every point. Planes that are not at a distance from one another are therefore not parallel planes. The adjective “parallel” thus implies a distance between the planes.

Normal vector: The normal vector is orthogonal to the plane and is used in the context of the invention to indicate the orientation of a plane. Example: A plane extending in a Cartesian coordinate system in parallel with the X-axis and with the Y-axis has a normal vector extending in the Z-axis direction.

Prism: If a straight line slides, without changing its direction, in space along the boundary lines of a planar n-vertex, it describes a prismatic surface. If two parallel planes are placed through this prismatic surface, then the portion of the prismatic surface between them is called a “prism.”

Point symmetry: Shapes of which the points can be made to coincide by an in-plane rotation of 180° about a point S are referred to as point-symmetrical. The point S is referred to as the center of symmetry or central point. In the drilling tool according to the invention, the point of symmetry is in the longitudinal axis of the drilling tool.

WO2005065872A1 discloses a replaceable disk drill having a removably attached cutting insert.

The cutting insert has a first end and a second end opposite thereto, a plurality of helical flutes formed in the cutting insert and extending axially from the first to the second end, a plurality of arcuate cutting edges formed on the edge of cut of the plurality of helical flutes and on the first end of the cutting insert, and at least two openings in the cutting-insert body which each extend from the helical flute through the cutting-insert body on an opposing, in principle planar, contact surface.

The cutting insert is attached to the main body by means of screws which are guided through the openings and the tangential contact surfaces of the cutting insert rest against the tangential support surfaces of the main body.

This type of attachment necessitates completely removing at least two screws with each replacement of the cutting disk, which is very time-consuming.

Furthermore, it is essential for mounting the cutting insert that there is a small gap between the cutting insert and the base body, and therefore accurate radial positioning of the cutting insert is not ensured. Repeated replacement of the cutting edges causes wear on these surfaces, so that the gap becomes larger and the accuracy of the radial positioning of the cutting insert decreases.

Another limitation of this type of attachment is the minimum possible drilling diameter of such a replaceable disk drill. As a result of the two openings, the cutting insert is greatly weakened in the case of a small bore diameter. The necessary attachment threads in the main body usually cannot be significantly smaller than a size of M 2.5 or M 2.2, and therefore the smallest possible drill diameter is limited to approximately 11 mm.

DE 19980707 B4 discloses a composite cutting tool and a cutting insert removably attached thereto. In order to attach the cutting insert to the cutting tool, the cutting insert is inserted between two clamping jaws of the main body. There is at least one hole in the cutting insert made of hard material, which leads to high production costs. A clamping screw is then inserted through the jaws and the cutting insert. By tightening the clamping screw, the cutting insert is clamped between the clamping jaws.

This requires complete removal of the screw(s) each time the cutting insert is replaced, which requires a great deal of time. In addition, the handling is relatively complex.

JP 2014205216 A discloses a composite cutting tool and a cutting insert removably attached thereto and having helical counter mating surfaces. The support surfaces of the main body of the cutting tool and the complementary contact surfaces on the cutting inserts are conical, which is very expensive to produce. The cutting insert is centered in the cutting tool by a pin, which also constitutes an increased production cost. The cutting insert is attached in the main body of the cutting tool by the elastic preload of the body in conjunction with the conical design of the support surfaces and the contact surfaces.

WO2015193874 A1 discloses a composite cutting tool and a cutting insert removably attached thereto and having helical rake faces. The cutting insert can be fixed and loosened without screwing. This requires fewer clamping forces of the cutting insert compared with other attachment concepts of a cutting insert. At high machining forces, caused by high-strength workpiece materials or progressive wear of the cutting edges of the cutting insert, or tool vibrations in the drilling process, or the withdrawal of the tool from the produced hole, these clamping forces can be exceeded and the cutting insert can be detached from its position, which restricts the range of application of the tool concept.

DE 10 2009 044 995 A1 discloses a cutting tool having a replaceable cutting insert. The cutting insert is centered by means of a central tube in the manner of a mating sleeve. The cutting insert is secured in the axial direction by said insert being pivoted, after introduction into a receptacle of the cutting tool, counter to the working direction of rotation, such that part of the cutting insert enters a complementary recess of the cutting tool and is thus secured, in a form-locking manner in the axial direction, against falling out.

U.S. Pat. No. 7,556,458 B2 discloses a cutting tool having a replaceable cutting insert. The cutting insert is centered by means of a central pin in a complementary central hole of the cutting tool. In this cutting tool, too, the cutting insert is secured against falling out by said insert being pivoted, after introduction into a receptacle of the cutting tool, relative to the cutting tool counter to the working direction of rotation of the cutting tool, such that a lug projecting beyond a contact surface in the direction of rotation enters a complementary groove of the cutting tool.

### SUMMARY OF THE INVENTION

The object of the invention is that of providing a drilling tool having a replaceable cutting disk and providing an associated replaceable cutting disk which overcomes the disadvantages of the prior art. In particular, the replaceable cutting disk should be centered and aligned in the drilling tool with very high accuracy. Replacing the replaceable cutting disk should be easy and reliable, even under the conditions of large-scale industrial production.

In the case of a drilling tool having a replaceable cutting disk, comprising a clamping end, a shank and a drill head, a receptacle for the replaceable cutting disk being formed on the drill head, the receptacle comprising two drivers, a support surface and a mating surface being formed on each driver, the normal vectors of the support surfaces and the mating surfaces extending orthogonally with respect to the longitudinal axis, the drivers being arranged point-symmetrically with respect to the longitudinal axis, this object is achieved according to the invention in that a centering surface is formed between the support surface and the mating surface of a driver, and in that the centering surface forms an angle α between 120° and 60° with the support surface. This geometry achieves particularly good torque transmission from the drilling tool to the cutting disk; the cutting disk can be replaced quickly and easily and it is easily possible to fix the cutting disk in the drilling tool even under cramped conditions in the working space of a machining center.

Preferably, the centering surfaces of the two drivers extend in parallel with one another. This further improves centering and alignment of the cutting disk in the drilling tool.

The normal vectors of the centering surfaces also extend orthogonally to the longitudinal axis of the drilling tool.

Due to the inventive design of the drilling tool, a prismatic space is formed between the drivers, which space can accommodate a complementarily shaped prismatic attachment portion of a replaceable cutting disk. The transmission of torque from the drill head to the replaceable cutting disk, which transmission is required for drilling, predominantly takes place from the support surfaces of the driver to complementarily shaped contact surfaces of the replaceable cutting disk.

The replaceable cutting disk is centered relative to the longitudinal axis or the axis of rotation of the drilling tool by means of the two centering surfaces and the complementarily shaped counter centering surfaces of the replaceable cutting disk.

As a result, very good alignment of the replaceable cutting disk in the direction of the longitudinal axis is ensured and at the same time the replaceable cutting disk is very well centered relative to the longitudinal axis of the drilling tool.

As a result, high machining performance with high service life of the replaceable cutting disk and a very high quality of the holes in terms of size, straightness and surface quality can be achieved.

In one embodiment of the invention, the support surfaces of the two drivers are mutually parallel and/or the mating surfaces of the two drivers are mutually parallel.

This leads to, inter alia, advantages in terms of production. In particular, the support surfaces of the two drivers can be produced for example in a machining operation using a side milling cutter. This results in a very high parallelism of these support surfaces. The centering surfaces can also be produced with high accuracy in a further step by means of an end mill, so that very tight tolerances are reliably maintained in the production of drilling tools. In conjunction with replaceable cutting disks that also have tight tolerances, exact alignment and centering of the replaceable cutting disks relative to the axis of rotation of the drilling tool is thus achieved.

In a particularly advantageous embodiment of the invention, the support surface on a driver and the mating surface on the same driver are mutually parallel. This simplifies the manufacture of both the drilling tool and the complementarily shaped replaceable cutting disk.

In order that the feed forces required for drilling can be transmitted safely between the drilling tool and the replaceable cutting disk, a base surface is formed at the transition between the drill head and the driver between the drivers, the base surface being rotationally symmetrical with respect to the longitudinal axis. The base surface is usually planar. This ensures that the feed forces transmitted from the base surface to the attachment portion of a replaceable cutting disk do not lead to tilting of the replaceable cutting disk and the accuracy of drilling is independent of the feed force as far as possible.

To secure the replaceable cutting disk against detaching, a slot is provided in the base surface which extends from the base surface towards the clamping end. The normal vector of the slot extends approximately in the direction of the bisector of the normal vectors of the support surface and the centering surface of a driver.

Perpendicularly to the slot, a stepped cross hole having an internal thread is provided in the drill head. There is a securing screw in the cross hole. When the securing screw is tightened, the drivers of the drill head are brought together slightly (less than 5/100 millimeters), thus securing the replaceable cutting disk in the gap between the drivers against detaching. The securing must be so stable that the replaceable cutting disk cannot be pulled out of the base body when the drill retracts.

Other variants of securing means are also possible. For example, it is possible for a depression to be provided in the attachment portion of the replaceable cutting disk and for a spring-loaded securing pin, which is fixed to the drill head, to retract into the depression when the replaceable cutting disk is inserted into the drill head.

It has proven to be advantageous if the centering surface forms an angle α between 105° and 75°, preferably an angle α of 90°, with the support surface. This ensures the best possible centering of the replaceable cutting disk between the drivers of the drill head.

The object mentioned at the outset is also achieved by a replaceable cutting disk for use in a drilling tool according to any of the preceding claims, the replaceable cutting disk comprising a front portion having the cutting edge(s) and an attachment portion, the attachment portion being designed such that it interacts in a form-locking manner with the drivers of the drilling tool. This means in particular that the attachment portion is usually formed as a prism of which the cross section corresponds to the gap between the drivers of the drill head.

The replaceable cutting disk according to the invention is claimed in claims 15 to 20. Because the attachment portion of the replaceable cutting disk according to the invention is designed to be complementary to the drivers of the drill head, there are similarities between the claims directed to the drilling tool and the claims directed to the replaceable cutting disk. The benefits that can be thus realized are also similar.

Further advantages and advantageous embodiments of the invention can be found in the following drawings and the description thereof in the claims. All of the features disclosed in the drawings, the description thereof and the claims may be essential to the invention both individually and in any combination with one another.

### BRIEF DESCRIPTION OF THE DRAWINGS

In the drawings:

FIGS. 1 and 2 show an embodiment of a drilling tool according to the invention in different isometric views;

FIG. 3 is a side view of a drilling tool according to the invention without a replaceable cutting disk;

FIG. 4 to 6 show different isometries of the drill head of the drilling tool according to the invention;

FIG. 7 is a view from the front of the drill head;

FIG. 8 to 11 are different isometric views of an embodiment of a replaceable cutting disk according to the invention;

FIG. 12 is a view of the drill point of the replaceable cutting disk according to the invention;

FIG. 13 is a view from below of the replaceable cutting disk according to the invention;

FIG. 14 is a side view of a drilling tool according to the invention with an inserted replaceable cutting disk;

FIG. 15 is a further isometric view of the drilling tool according to the invention with an inserted replaceable cutting disk and

FIG. 16 is a view of the drill point of the drilling tool according to the invention with an inserted replaceable cutting disk,

FIG. 17 is a longitudinal section through the drill head and

FIG. 18 is a cross section through the drilling tool at the level of the securing screw.

### DESCRIPTION OF THE EMBODIMENTS

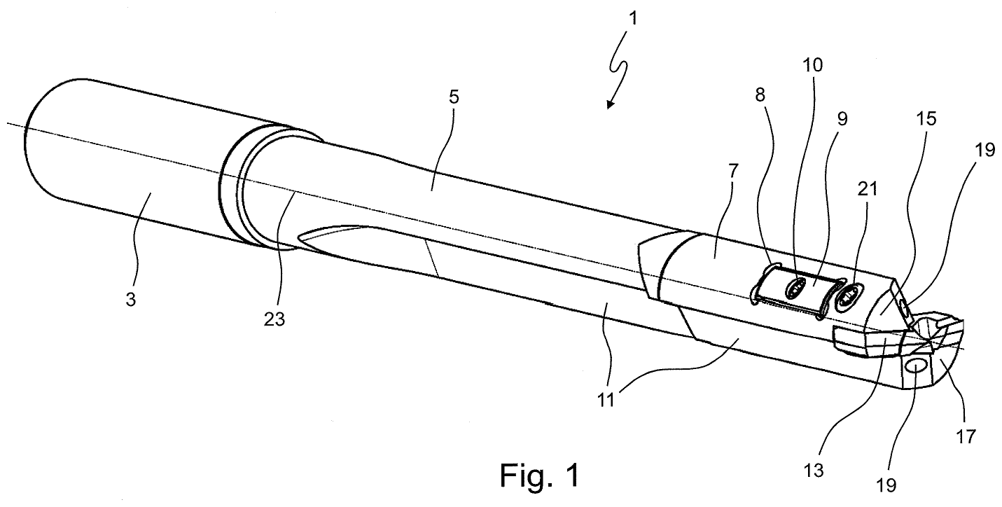

With regard to FIG. 1 to 16, two embodiments of drilling tools according to the invention and of an associated replaceable cutting disk are shown.

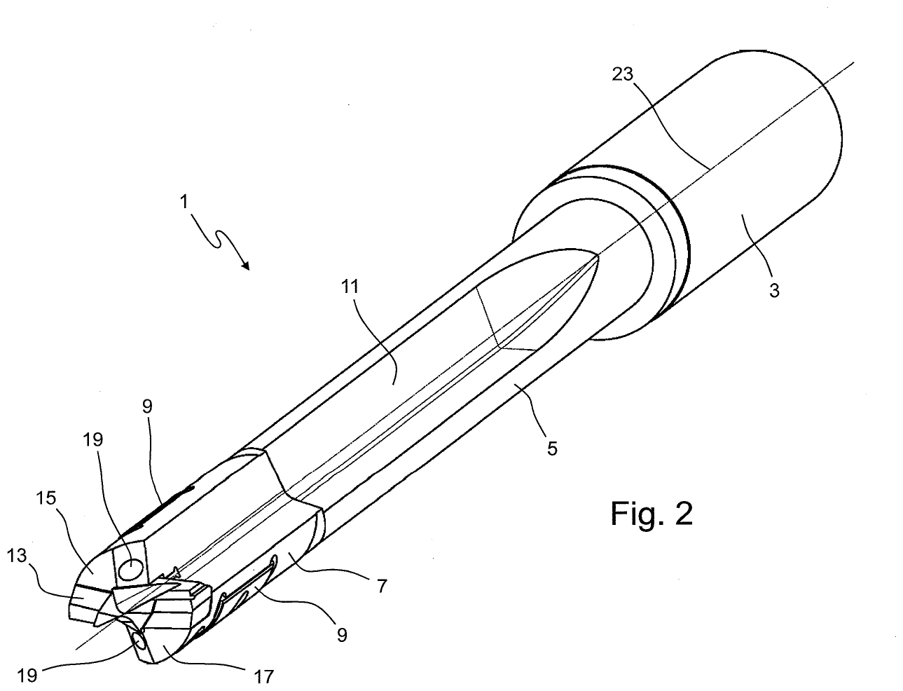

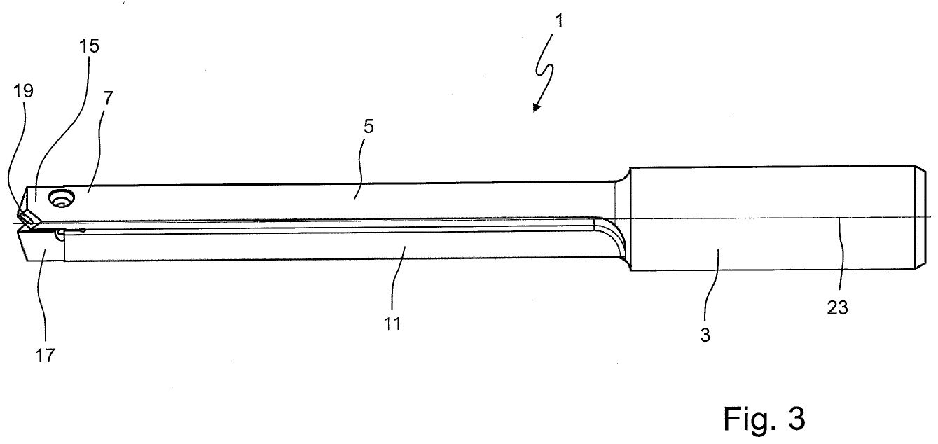

The first embodiment (FIGS. 1 and 2) shows a multi-part tool predominantly for greater drilling depths, in addition to guide strips. The second embodiment (FIGS. 3, 4, 14 and 15) shows a one-piece tool predominantly for smaller drilling depths.

The form-locking connection between the drill head and the replaceable cutting disk is always the same in both embodiments.

FIG. 1 shows a drilling tool 1 according to the invention in an isometric view, which tool consists of a plurality of parts. The drilling tool 1 comprises a clamping end 3, a shank 5 and a drill head 7.

This drawing relates to a constructed drilling tool, in which the clamping end 3, shank 5 and drill head 7 consist of different components and are connected to one another, for example by soldering. This design is primarily used when the tool length exceeds approximately 8 to 12 times the diameter of the drill. In this way, lengths up to more than 100 times the diameter of the drill can be realized.

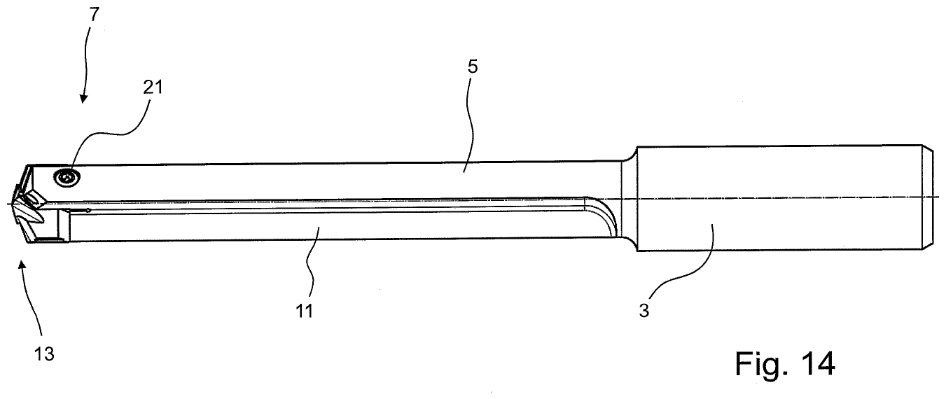

The drilling tool according to the invention can also be designed in one piece, as shown for example in FIGS. 3 and 14. In this case, the clamping end 3, shank 5 and drill head 7 are made in one piece.

In the embodiment shown in FIG. 1, a replaceable guide strip 9 is arranged on the drill head 7. It is held in a recess 8 in the drill head 7 by means of a screw 10. A bottom of the recess 8 often does not extend exactly in parallel with the longitudinal axis 23 of the drilling tool, but is slightly inclined, so that the front end of the guide strip 9 rotates during drilling on a slightly larger diameter than the rear end. As a result, the contact surface between the hole and the guide strip 9 is limited to the front end. If the front end of the guide strip 9 is worn, the guide strip 9 can be rotated once by 180°, so that the unworn end that was previously at the rear reaches the front end of the recess 8.

The guide strip 9 is held in the recess 8 by means of a screw 10. The screw 10 is screwed into an internal thread (not visible in FIG. 1) in the drill head 7. If the guide strip 9 is worn, it is replaced by a new guide strip. This design is also primarily useful for tools of which the length exceeds approximately 8 to 12 times the diameter of the tool. It can also be used with shorter tools if particularly high demands are placed on the straightness of the hole.

Two flutes 11 are formed in the shank 5 and the drill head 7, although only one of these is visible in FIG. 1. At the front end of the drilling tool 1, there is a replaceable cutting disk 13 according to the invention, which is held in a form-locking manner between two drivers 15 and 17. In FIG. 1, the cutting edges of the replaceable cutting disk 13 are clearly visible. Furthermore, cooling channels 19 are visible in the drivers 15.

The cooling channels 19 extend through the drill head 7 and the shank 5 in a known manner.

The securing screw 21 shown in FIG. 1 is used to clamp the replaceable cutting disk 13 in the drill head 7. For this purpose, the drivers 15 and 17 are very easily moved towards one another by means of the securing screw 21 when the replaceable cutting disk 13 is inserted. The clamping prevents the replaceable cutting disk 13 from being detached from the drill head 7 and ensures form-locking positioning of the replaceable cutting disk 13 in the drill head 7. A longitudinal axis of the drilling tool 1 is denoted by the reference sign 23.

FIG. 2 shows the drilling tool 1 from a different perspective. The design details will be explained in more detail with reference to FIG. 3 et seq.

FIG. 3 is a side view of the second embodiment of a drilling tool 1 according to the invention without a replaceable cutting disk 13 and without a securing screw 21.

It is preferred for the securing screw 21 not to penetrate the replaceable cutting disk 13 in a manner requiring a hole in the replaceable cutting disk 13. The introduction of a hole in a replaceable cutting disk 13 made of a very hard material is complex and expensive. It also weakens the replaceable cutting disk 13. As a result, drilling tools having a replaceable cutting disk which has been drilled through require a specific minimum diameter.

The drilling tools according to the invention are not subject to this restriction, which extends their field of application towards smaller drill diameters.

Because the securing screw in the drilling tool according to the invention 1 does not penetrate the replaceable cutting disk 13, the securing screw 21 does not need to be rotated out of the drill head 7 in order to replace a replaceable insert 13 with or without a recess 45, but rather it is sufficient if the securing screw 21 is slightly loosened. The clamping of the replaceable cutting disk 13 between the drivers 15 and 17 is then released and the replaceable cutting disk 13 can be easily pulled forward out of the drill head 7.

It is preferable for the replaceable cutting disk 13 to have an open recess 45 at the end thereof opposite the cutting edges. The optional recess 45 ensures that the distance of the screw to the drill point is as small as possible, which improves the clamping of the replaceable cutting disk 13 in the drill head 7 without needing to introduce a hole in the replaceable cutting disk 7.

In the second embodiment shown in FIG. 3, the clamping end 3, shank 5 and drill head 7 are made in one piece.

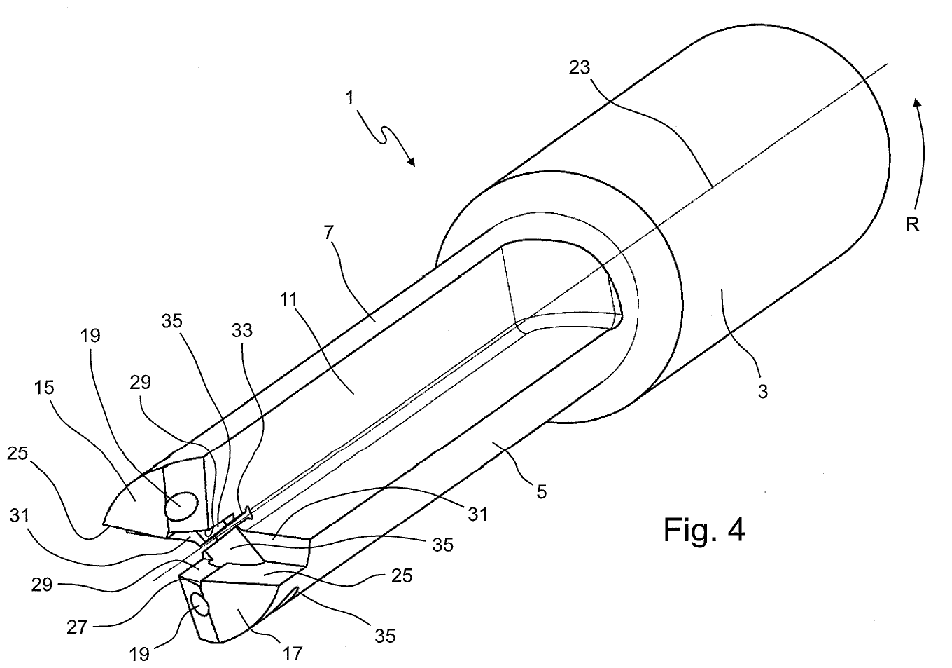

FIG. 4 is a slightly enlarged isometric view of the drill head 7 and the two drivers 15 and 17. Between the two drivers 15 and 17, a prismatic space is recessed, into which the attachment portion of the replaceable cutting disk (not shown), which portion is also prismatic, can be introduced. The replaceable cutting disk is introduced from the tip of the drilling tool 1 in the direction of the longitudinal axis 23 of the drilling tool 1. The longitudinal axis 23 is simultaneously the axis of rotation of the drilling tool 1. The driver 17 is point-symmetrical with respect to the driver 15. This means that it has the same functional surfaces. However, these surfaces are not clearly visible in FIG. 4.

A direction of rotation of the drilling tool 1 is indicated by the curved arrow R.

The driver 17 has a support surface 25 and a mating surface 29. The support surface 25 and the mating surface 29 of a driver 15 or 17 are mutually parallel in this embodiment. However, this does not have to be the case. The support surface 25 and the mating surface 29 of a driver 15 or 17 may also form angles between 180° and 135° (not shown).

A centering surface 27 is formed between the support surface 25 and the mating surface 29, which centering surface ultimately “bridges” the distance between the support surface 25 and the mating surface 29 on the drivers 15, 17.

The support surface 25, the centering surface 27 and the mating surface 29 of the driver 17 together with the corresponding surfaces 25, 27 and 29 of the driver 15 form a prismatic space into which the replaceable cutting disk (not shown) can be inserted.

The replaceable cutting disk 13 is centered and aligned relative to the longitudinal axis 23 of the drill head 7 almost exclusively by means of the support surface 25 and the centering surface 27 of the drivers 17. In this context, the mating surface 29 assumes no function or only a very minor function. It is therefore possible to dispense with the mating surface 29 and the complementary counter mating surface 41 of the replaceable cutting disk 13.

At the bottom of this above-mentioned prismatic space there is a base surface 31, which is formed as a planar surface. The base surface 31 serves as an end stop for the replaceable cutting disk 13 and transmits the feed forces from the drilling tool 1 to the replaceable cutting disk 13.

The torque required for machining is transmitted substantially via the two support surfaces 25 of the drivers 15 and 17 and to a small extent by the two centering surfaces 27 of the drivers 15 and 17. The replaceable cutting disk is centered relative to the longitudinal axis 23 of the drilling tool 1 and the replaceable cutting disk 13 is aligned in the direction of the longitudinal axis 23 predominantly by means of the centering surfaces 27 of the drivers 15 and 17.

The two centering surfaces 27 of the drivers 15 and 17 also prevent the replaceable cutting disk 13 from losing contact with the support surfaces 25.

In FIG. 4, it can be clearly seen that the base surface 31 is interrupted by a slot 33. A cross hole 35 designed as a stepped hole and penetrated at least in part by the two drivers 15 and 17 extends perpendicularly to the slot 33. The details of the drivers 15 and 17 are made clear in the following in further depictions.

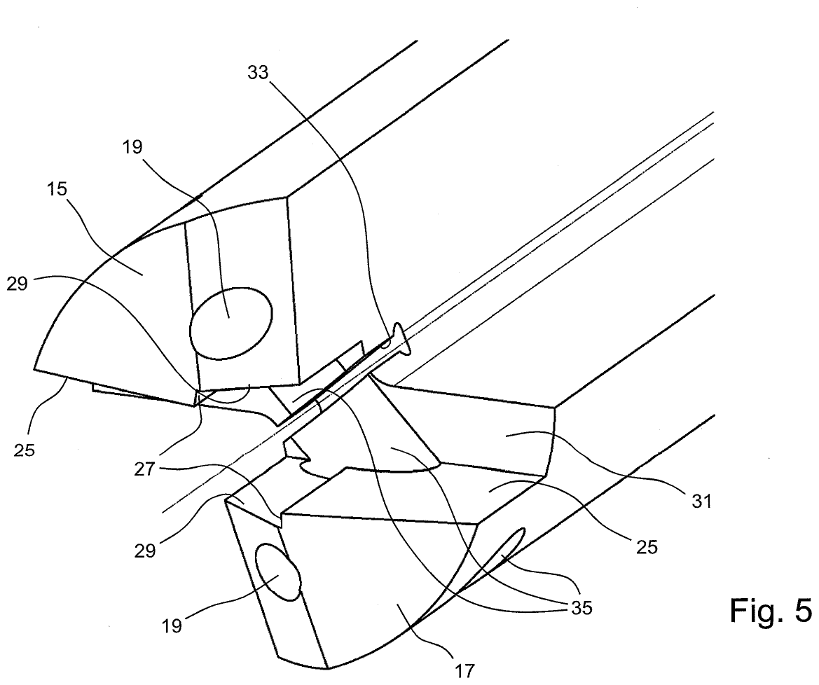

FIG. 5 is a further enlarged view of the tip of the drill head 7 according to FIG. 4.

In FIG. 5, it can be clearly seen that the cross hole 35 is a stepped hole. The diameter of the cross hole 35 in the driver 17 is larger than in the driver 15.

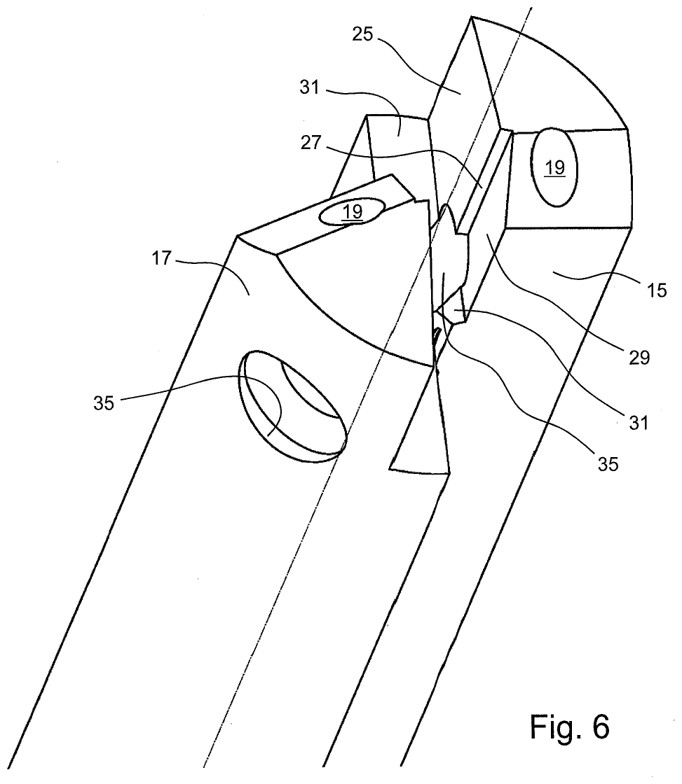

FIG. 6 shows the tip of the drill head 7, also enlarged here, in a different isometric view.

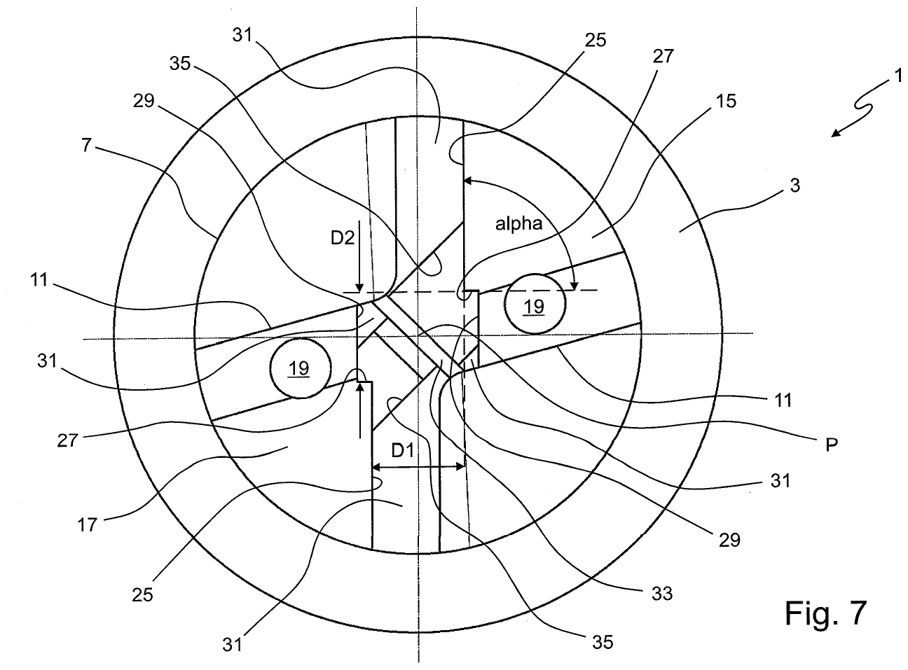

FIG. 7 is a view from the front of the drill head 7 and the drilling tool 1. In this view, it can be clearly seen that the support surfaces 25 and the mating surfaces 29 of each driver 15, 17 extend in parallel with one another.

The distance between the support surfaces 25 and mating surfaces 29 is bridged by the centering surface 27. In this embodiment, the support surface 25 and the centering surface 27 form an angle alpha of 90°. This angle can also vary; it is preferably between 120° and 60°.

It is clear in FIG. 7 that the drivers 15 and 17 are arranged point-symmetrically with respect to one another. The point of symmetry P is in the longitudinal axis 23 of the drilling tool 1.

It is also clear in FIG. 7 that the two support surfaces 25 of the drivers 15 and 17 are mutually parallel. The same applies with respect to the centering surfaces 27 of the two drivers 15 and 17 and the mating surfaces 29 of the drivers 15 and 17. This results from the point symmetry of the drivers 15, 17.

A distance between the support surfaces 25 of the two drivers 15 and 17 is denoted by D₁ in FIG. 7. The distance between the centering surfaces 27 of the two drivers 15 and 17 is denoted by D₂. For reasons of clarity, the distance of the mating surfaces 29 of the two drivers 15 and 17 has not been shown in FIG. 7.

The base surface 31 consists of four segments, because the base surface 31 is interrupted by the slot 33 and by the cross hole 35 designed as a stepped hole.

The base surface 31 is delimited by the flutes 11 and the support surfaces 25, 27 and 29 of the two drivers 15 and 17.

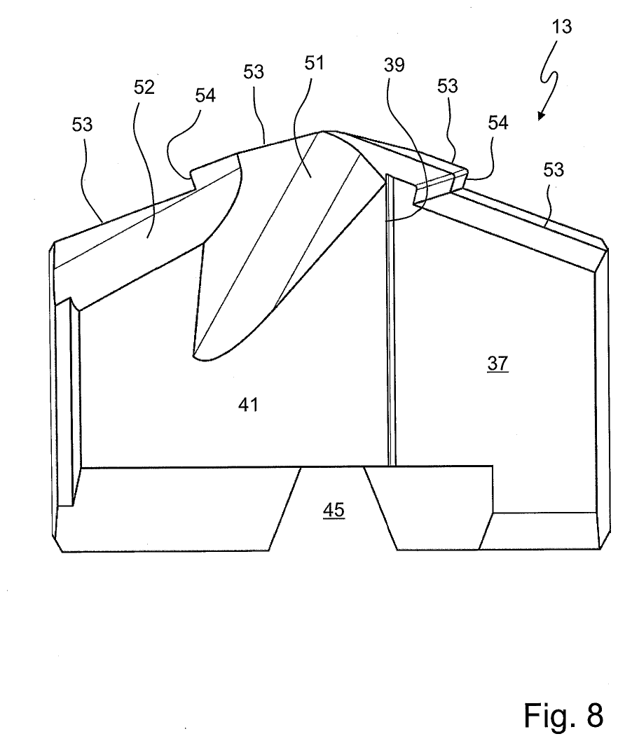

FIG. 8 shows an isometric view of a replaceable cutting disk 13 according to the invention which is compatible with the drill head 7 of the drilling tool 1.

The selected cutting geometries, which are naturally at the top of the replaceable cutting disk 13, are merely exemplary. It is also possible for other cutting geometries and chip formers 52 and chip breakers 54 to be formed on a replaceable cutting disk 13 according to the invention.

The replaceable cutting disk 13 is, with the exception of the tip, a prismatic body which is delimited by a plurality of surfaces. A contact surface 37, a counter centering surface 39 and a counter mating surface 41 can be seen in FIG. 8.

It is also clear in FIG. 8 that the lower end of the replaceable cutting disk 13 has a recess 45. This recess 45 creates space for a securing screw 21 arranged in the cross hole 35.

FIG. 8 also clearly shows the main cutting edges 53, a chip former 52, and chip breakers 54 of the replaceable cutting disk 13. The cutting geometry shown is to be understood as an example, but not as a limitation.

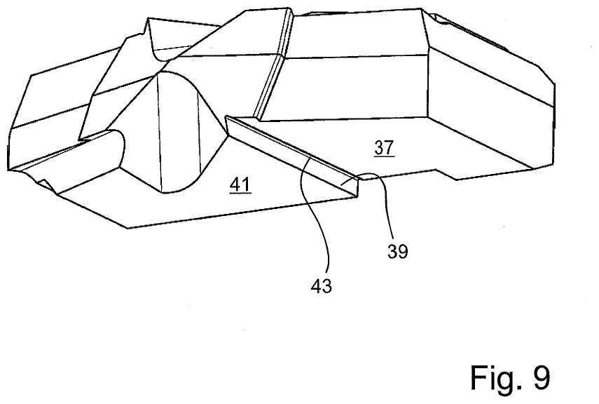

These surfaces 37, 39 and 41 are even more visible in FIG. 9. It can be seen particularly clearly in FIG. 9 that an undercut 43 is formed at the transition between the contact surface 37 and the counter centering surface 39. This undercut 43 ensures that the surfaces 37 and 39 lie flat against the support surface 25 and the centering surface 27 of the drivers 15 and 17 of the drill head and improves the mountability of the replaceable cutting disk 13.

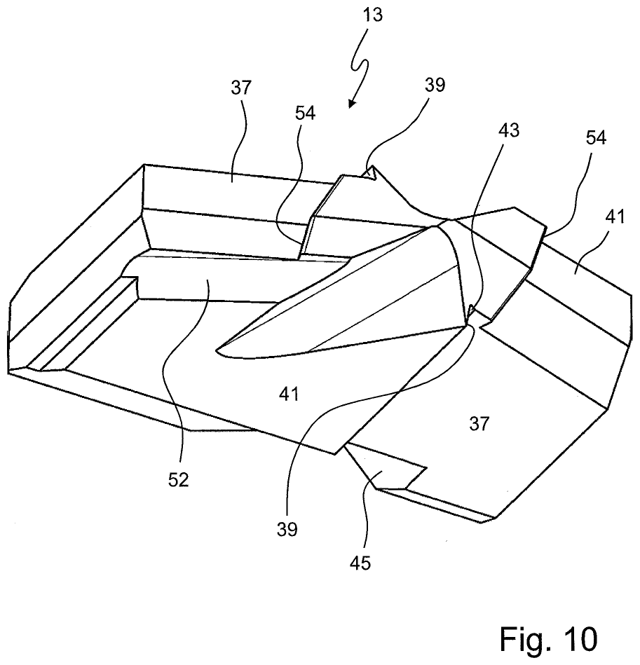

FIG. 10 shows a further isometric view of a replaceable cutting disk 13 according to the invention.

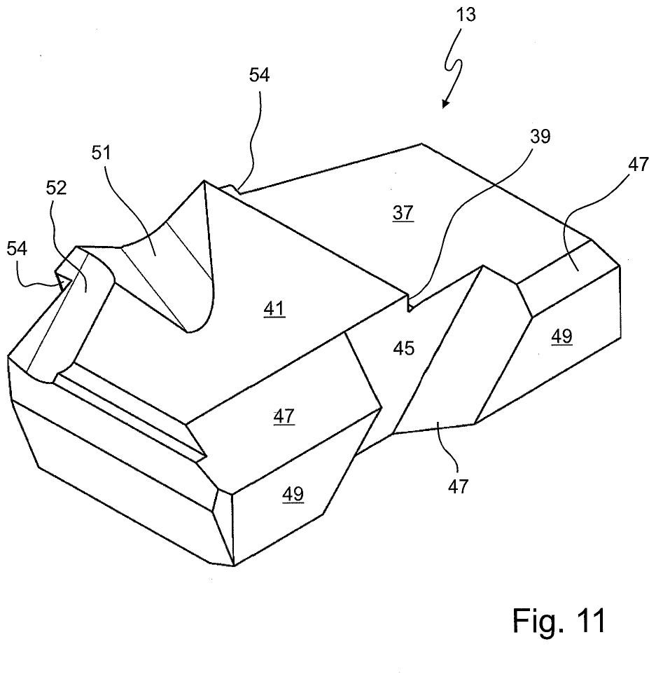

In FIG. 11, the replaceable cutting disk is shown obliquely from below. In this view, the recess 45 that is open toward the end of the replaceable cutting disk can be clearly seen.

It can also be seen that the lower end of the replaceable cutting disk 13 has bevels 47, which facilitate the insertion of the replaceable cutting disk between the two drivers 15 and 17 of the drill head 7. An end surface 49 interrupted by the recess 45 is present between the bevels 47. The end surface 49 rests on the base surface 31 of the drill head 7 when the replaceable cutting disk 13 is inserted into the drill head 7.

It can also be seen in FIG. 11 that a chip former 52 is formed in the counter mating surface 41 at the upper end of the replaceable cutting disk 13. Furthermore, it can be seen that, in the center of the front region of the replaceable cutting disk 13, a groove 51 is recessed from the counter mating surfaces 41. This “thinning” reduces the forces that occur during drilling.

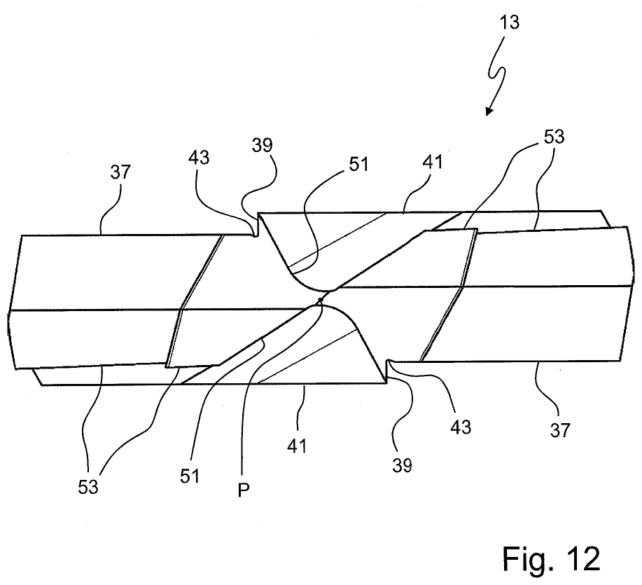

FIG. 12 is a view of the drill point or the tip of the replaceable cutting disk 13. In this view, it is clear that the contact surface 37, the counter centering surfaces 39 and the counter mating surface 41 are complementary to the support surfaces 25, the centering surfaces 27 and the mating surfaces 29 of the drivers 15 and 17. This means that the replaceable cutting disk 13 can be inserted from above into the drill head 7 between the drivers 15 and 17.

It is advantageous if a low-backlash sliding seat is provided between the drivers 15 and 17 and the attachment portion of the cutting disk 13. The less backlash occurs, the more accurately the replaceable cutting disk 13 is centered and aligned in the drill head 7.

The main cutting edges of the replaceable cutting disk 13 are denoted by 53 in FIG. 12.

From this view, it is clear that the replaceable cutting disk 13 is also point-symmetrical with respect to a point of symmetry P. This point of symmetry P is in the axis of rotation or the longitudinal axis of the drill head.

Taking this into account, it is clear that the centering surfaces 27 of the drivers 15 and 17, in conjunction with the counter centering surfaces 39 of the replaceable cutting disk 13, ensure the centering or the central positioning of the replaceable cutting disk 13 between the drivers 15 and 17.

Because the centering surfaces 27 of the drivers 15 and 17, as well as the counter centering surfaces 39 of the replaceable cutting disk 13, have a certain axial extent, the replaceable cutting disk is aligned in the direction of the longitudinal axis of the drilling tool as a result.

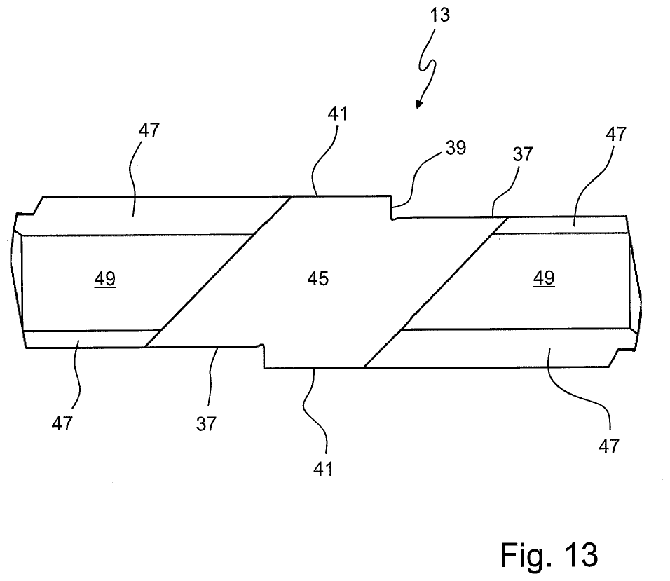

In FIG. 13, the replaceable cutting disk 13 is shown from below. The prismatic cross section of the replaceable cutting disk 13, which is delimited by the surfaces 37, 39 and 41, can be clearly seen here, too. The recess 45, the insertion bevels 47 and the end surfaces 49 are also clearly visible.

FIG. 14 is a side view of the drilling tool 1 according to the invention with an inserted replaceable cutting disk 13. In FIG. 14, the replaceable cutting disk 13 is inserted from the left in the longitudinal axis 23 into the space delimited by the drivers 15 and 17. In this case, a fit between the drivers 15 and 17 and the replaceable cutting disk 13 with the least possible backlash is desirable.

When the end surface 49 of the replaceable cutting disk 13 rests on the base surface 31 of the drill head, the replaceable cutting disk has reached its position. The disk is then aligned and centered with high accuracy. This is substantially due to the centering surfaces 27 and the counter centering surfaces 39.

If the securing screw 21 is then tightened slightly, the drivers 15 and 17 move by a few hundredths of a millimeter towards one another and, by defined clamping, secure the replaceable cutting disk 13 against falling out and against the detachment of the replaceable cutting disk 13 from the drill head when the drilling tool 1 is pulled out of the hole. The forces required for machining are not transmitted by the securing screw 21. Instead, this is carried out by means of the surfaces 25 and both drivers 15 and 17 and the corresponding counter surfaces 37 and 39 of the replaceable cutting disk 13.

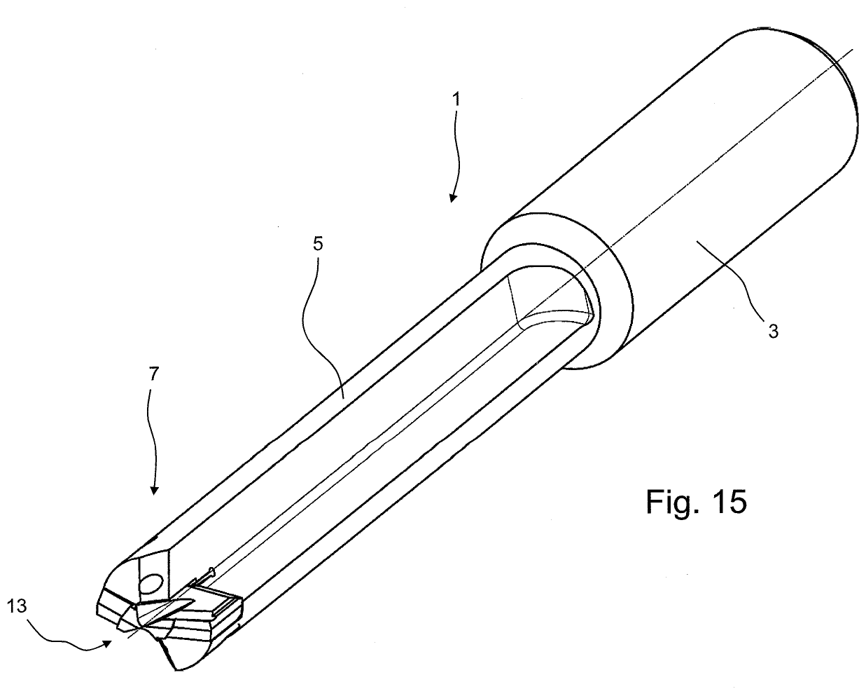

FIG. 15 shows the drilling tool 1 according to the invention with an inserted replaceable cutting disk in another view.

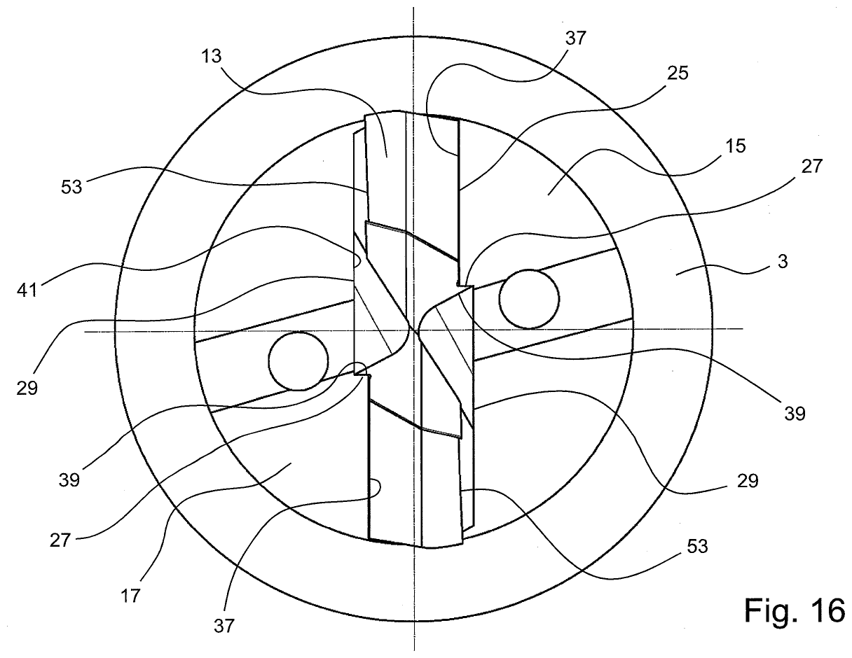

FIG. 16 is a front view of the drilling tool according to the invention with an inserted replaceable cutting disk. The form-locking connection between the replaceable cutting disk 13 and the drivers 15 and 17 of the drilling tool can be seen very clearly from this illustration. It is also clear how the centering surfaces 27 and the counter centering surfaces 39 contribute to the positioning, alignment and centering of the replaceable cutting disk 13 relative to the drill head 7.

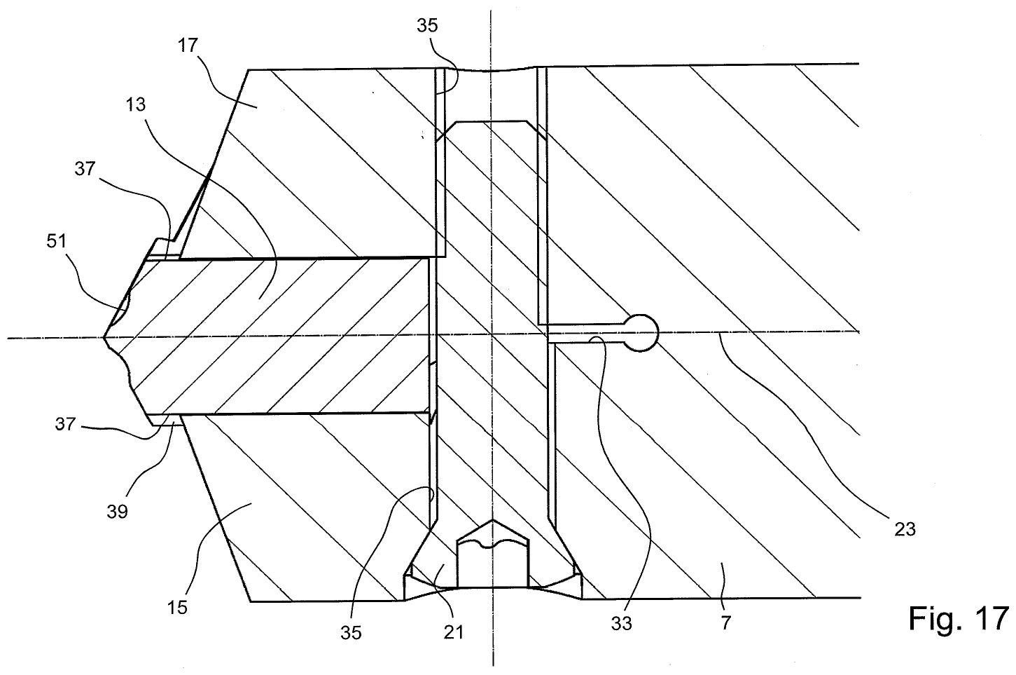

FIG. 17 is a longitudinal section through the drill head 7 with a replaceable cutting disk 13 and a screwed-in securing screw 21. In this view, it is clear that the cross hole 35 is designed as a stepped hole and has an internal thread in the driver 17 into which the securing screw 21 is screwed. A countersink is formed in the driver 15, on which countersink the countersunk head of the securing screw 21 rests. By tightening the securing screw 21, the drivers 15 and 17 are moved towards one another slightly. Because the drivers 15, 17 receive the replaceable cutting disk 13 over a certain length in the direction of the longitudinal axis 23 (axial direction), the replaceable cutting disk 13 is aligned relative to the longitudinal axis 23.

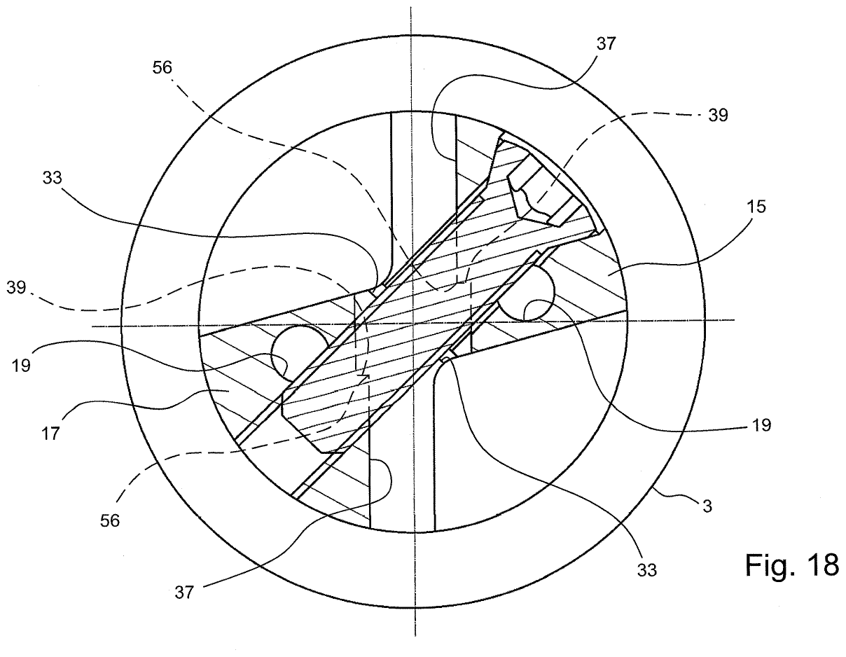

FIG. 18 is a section through the drill head 7 at the level of the stepped cross hole 35, also with a screwed-in securing screw 21. The parts of the support surfaces 25 and the centering surfaces 27 that are not visible in the intersection planes are shown as broken lines. It can therefore be clearly seen that the support surfaces 25 and the centering surfaces 27 each form a vertex 56. In the embodiment shown, these two vertices 56 are aligned approximately with the longitudinal axis of the securing screw 21 and the cross hole 35.

When the securing screw 21 is tightened, it draws the vertices 56 formed by the support surfaces 25 and the centering surfaces 27 towards one another such that they clamp and secure a replaceable cutting disk 13 (not shown in FIG. 18) to their complementary contact surfaces 37 and counter centering surfaces.

The mating surfaces 29 of the driver and the counter mating surfaces 41 of the replaceable cutting disk 13 are not required for this purpose.

1. Drilling tool having a replaceable cutting disk, comprising a shank, a clamping end, a drill head and a longitudinal axis, a receptacle for the replaceable cutting disk being formed on the drill head, the receptacle comprising two drivers, a support surface being formed on each driver, the normal vectors of the support surfaces extending orthogonally with respect to the longitudinal axis, the drivers being arranged point-symmetrically with respect to the longitudinal axis, characterized in that a centering surface is formed adjacently to the support surface of a driver, and in that the centering surface forms an angle (alpha) between 120° and 60° with the support surface.

2. Drilling tool according to claim 1, characterized in that a mating surface is formed adjacently to the centering surface.

3. Drilling tool according to claim 1, characterized in that the centering surfaces of the two drivers are mutually parallel.

4. Drilling tool according to claim 1, characterized in that the support surfaces of the two drivers are at least one of mutually parallel and/or in that the mating surfaces of the two drivers are mutually parallel.

5. Drilling tool according to claim 2, characterized in that the support surface and the mating surface of a driver are mutually parallel.

6. Drilling tool according to claim 1, characterized in that a base surface is formed at the transition between the drill head and drivers between the drivers, and in that the base surface is rotationally symmetrical with respect to the longitudinal axis.

7. Drilling tool according to claim 6, characterized in that the base surface is planar, and in that the normal vector of the base surface extends in parallel with the longitudinal axis.

8. Drilling tool according to claim 6, characterized in that a slot is provided in the drill head which extends from the base surface towards the clamping end.

9. Drilling tool according to claim 1, characterized in that the normal vector of the slot extends approximately in the direction of the bisector of the normal vectors of the support surface and the mating surface of a driver.

10. Drilling tool according to claim 1, characterized in that the drill head has securing means for securing the replaceable cutting disk against falling out.

11. Drilling tool according to claim 10, characterized in that the securing means comprise a cross hole formed as a stepped hole in the drill head, in that the cross hole penetrates the slot, and in that the cross hole has an internal thread on one side of the slot.

12. Drilling tool according to claim 10, characterized in that the securing means comprise a cross hole formed as a stepped hole in the drill head, in that the cross hole penetrates the two drivers, and in that the cross hole has an internal thread in one driver.

13. Drilling tool according to claim 1, characterized in that the centering surface forms an angle (alpha) between 105° and 75° with the support surface.

14. Drilling tool according to claim 1, characterized in that the drill head comprises a guide strip.

15. Replaceable cutting disk for use in a drilling tool comprising a shank, a clamping end, a drill head and a longitudinal axis, a receptacle for the replaceable cutting disk being formed on the drill head, the receptacle comprising two drivers, a support surface being formed on each driver, the normal vectors of the support surfaces extending orthogonally with respect to the longitudinal axis, the drivers being arranged point-symmetrically with respect to the longitudinal axis, characterized in that a centering surface is formed adjacently to the support surface of a driver, and in that the centering surface forms an angle (alpha) between 120° and 60° with the support surface, wherein the replaceable cutting disk comprises a front portion, a prismatic attachment portion and a longitudinal axis, wherein the front portion has one or more blades, and wherein the attachment portion is designed so as to interact in a form-locking manner with the drivers of the drilling tool.

16. Replaceable cutting disk according to claim 15, characterized in that the attachment portion comprises two contact surfaces and at least one of two counter mating surfaces or two counter centering surfaces, the normal vectors of the contact surface, counter mating surfaces and counter centering surfaces extending orthogonally with respect to the longitudinal axis, a counter centering surface is arranged between a contact surface and a counter mating surface in each case, and the counter centering surfaces forming an angle (alpha) between 120° and 60° with the adjacent contact surfaces.

17. Replaceable cutting disk according to claim 16, characterized in that the two counter centering surfaces are mutually parallel.

18. Replaceable cutting disk according to claim 16, characterized in that the two contact surfaces are at least one of mutually parallel or the two counter mating surfaces are mutually parallel.

19. Replaceable cutting disk according to claim 15, characterized in that a recess is formed at one end of the attachment portion, which recess is aligned with the cross hole of the drilling tool.

20. Replaceable cutting disk according to claim 15, characterized in that the counter centering surface forms an angle (alpha) between 105° and 75° with the contact surface.
